(19) United States
(12) Patent Application Publication
(10) Pub. No.: US 2026/0053195 A1
(43) Pub. Date: Feb. 26, 2026

(54) A HOLDER ASSEMBLY FOR A CARTRIDGE FOR AN AEROSOL-GENERATING SYSTEM

(71) Applicant: Philip Morris Products S.A., Neuchatel (CH)

(72) Inventors: Olivier BLÄTTLER, Lamboing (CH); David Murray CROSS, Hertfordshire (GB); Onur DAYIOGLU, Neuchâtel (CH); Guillaume FREDERICK, Valff (FR); Emeric Romain GRANDJEAN, Lausanne (CH); Stuart Michael Ruan JONES, Hertfordshire (GB); Patrick Charles SILVESTRINI, Neuchâtel (CH); Dominique Paul Gabriel STOHR, Belfaux (CH); Amir FERIANI, Saint-Blaise (CH)

(73) Assignee: Philip Morris Products S.A., Neuchatel (CH)

(21) Appl. No.: 19/099,687

(22) PCT Filed: Aug. 11, 2023
(86) PCT No.: PCT/EP2023/072320

§ 371 Date: Jan. 29, 2025

(30) Foreign Application Priority Data
Aug. 11, 2022 (EP) 22190016.0

(51) Int. Cl. A24F 40/465; A24F 40/10; A24F 40/42; A24F 40/44; A24F 40/48; A24F 40/70; H05B 6/10

(52) U.S. Cl. CPC A24F 40/465; A24F 40/10; A24F 40/42; A24F 40/44; A24F 40/48; A24F 40/70; H05B 6/108

(57) ABSTRACT

A holder assembly for a cartridge for an aerosol-generating system, the holder assembly including: a susceptor assembly including a wicking element having a planar shape and including a first side portion, a second side portion, and a central portion extending between the first side portion and the second side portion, and a susceptor element extending around at least a part of the central portion of the wicking element; and a holder defining an airflow channel, the holder including a first slot and a second slot opposite the first slot, and the first side portion of the wicking element being received within the first slot and the second side portion of the wicking element being received within the second slot so that the central portion of the wicking element and the susceptor element are positioned within the airflow channel.

The present disclosure relates to a holder assembly for a cartridge for an aerosol-generating system. The present disclosure also relates to a method of manufacturing a holder assembly for a cartridge for an aerosol-generating system.

Aerosol-generating systems configured to generate inhalable aerosol from a liquid aerosol-forming substrate are known in the art. It is also known for such systems to employ an inductive heating mechanism to generate heat for vaporising the aerosol-forming substrate. Inductive heating mechanisms typically include an inductor coil arranged around a susceptor element. Where the aerosol-forming substrate is a liquid aerosol-forming substrate, a wicking element may be provided to convey liquid from a reservoir of the liquid aerosol-forming substrate towards the susceptor element. Alternating current flow through the inductor coil generates a varying magnetic field that induces eddy currents in the susceptor element, thereby heating the susceptor element. The heat from the susceptor element vaporises liquid aerosol-forming substrate from the wicking element in the vicinity of the susceptor element. An airflow passing over the susceptor element entrains the vapour. The entrained vapour cools and condenses to form an aerosol, for inhalation by a user.

It would be desirable to improve the heating of a liquid aerosol-forming substrate by a susceptor element while also facilitating manufacture of a system comprising the susceptor element.

According to a first aspect of the present disclosure there is provided a holder assembly for a cartridge for an aerosol-generating system. The holder assembly may comprise a susceptor assembly. The susceptor assembly may comprise a wicking element. The susceptor assembly may comprise a susceptor element. The wicking element may have a planar shape. The wicking element may comprise a first side portion, a second side portion, and a central portion extending between the first side portion and the second side portion. The susceptor element may extend around at least a part of the central portion of the wicking element. The holder assembly may comprise a holder defining an airflow channel. The holder may comprise a first slot and a second slot opposite the first slot. The first side portion of the wicking element may be received within the first slot. The second side portion of the wicking element may be received within the second slot. The central portion of the wicking element and the susceptor element may be positioned within the airflow channel.

According to a second aspect of the present disclosure there is provided a holder assembly for a cartridge for an aerosol-generating system. The holder assembly comprises a susceptor assembly, the susceptor assembly comprising a wicking element and a susceptor element. The wicking element has a planar shape and comprises a first side portion, a second side portion, and a central portion extending between the first side portion and the second side portion. The susceptor element extends around at least a part of the central portion of the wicking element. The holder assembly also comprises a holder defining an airflow channel. The holder comprises a first slot and a second slot opposite the first slot. The first side portion of the wicking element is received within the first slot and the second side portion of the wicking element is received within the second slot. The central portion of the wicking element and the susceptor element are positioned within the airflow channel.

Advantageously, providing a wicking element having a planar shape may increase or maximise the surface area of the wicking element compared to other shapes. Advantageously, increasing or maximising the surface area of the wicking element may improve or maximise the vaporisation of a liquid aerosol-forming substrate from the wicking element.

Advantageously, providing the susceptor element around a central portion of the wicking element may reduce or minimise the transfer of heat from the susceptor element to the holder. Advantageously, this may increase or maximise heating of the wicking element by the susceptor element. Preferably, the susceptor element extends around only the central portion of the wicking element. In other words, preferably the susceptor element does not contact the first side portion of the wicking element, the second side portion of the wicking element, or the holder.

Advantageously, positioning the first and second side portions of the wicking element in first and second slots on the holder may facilitate correct positioning of the central portion of the wicking element and the susceptor element in the airflow channel. Advantageously, the first and second slots may facilitate manufacture of the holder assembly by insertion of the first and second side portions of the wicking element into the first and second slots respectively. Advantageously, the first and second slots may facilitate the transfer of liquid aerosol-forming substrate to the central portion of the wicking element by the first and second side portions of the wicking element.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth. The aerosol-forming substrate may form part of a cartridge or an aerosol-generating article configured for engagement with the aerosol-generating device.

As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-forming substrate” refers to a substrate consisting of or comprising an aerosol-forming material that is capable of releasing volatile compounds upon heating to generate an aerosol.

As used herein, a “susceptor element” means an element that is heatable by penetration with a varying magnetic field. A susceptor element is typically heatable by at least one of Joule heating through induction of eddy currents in the susceptor element, and hysteresis losses.

Preferably, only the first side portion of the wicking element is received within the first slot and only the second side portion of the wicking element is received within the second slot. In other words, preferably no other components of the holder assembly are received within the first slot and the second slot. Advantageously, positioning only the first side portion of the wicking element in the first slot and positioning only the second side portion of the wicking element may facilitate a seal between the wicking element and the holder. Advantageously, a seal between the wicking element and the holder may reduce or prevent leakage of liquid aerosol-forming substrate into the airflow channel between the first slot and the first side portion of the wicking element and between the second slot and the second side portion of the wicking element.

The holder may comprise a tubular portion at least partially defining the airflow channel, wherein the first slot and the second slot are defined by the tubular portion. Preferably, the first slot and the second slot are positioned on opposite sides of the airflow channel. Advantageously, positioning the first slot opposite the second slot may facilitate positioning of the susceptor assembly centrally within the airflow channel. Advantageously, positioning the first slot opposite the second slot may facilitate insertion of the first and second side portions of the planar wicking element into the first and second slots respectively during manufacture of the holder assembly.

The airflow channel may define a longitudinal direction extending between a first end of the airflow channel and a second end of the airflow channel.

Preferably, the planar shape of the wicking element extends parallel with the longitudinal direction. Advantageously, positioning the planar shape of the wicking element parallel with the longitudinal direction may position the planar shape of the wicking element parallel to airflow through the airflow channel during use. Advantageously, a parallel airflow may increase or maximise the flow of vaporised liquid aerosol-forming substrate away from the susceptor assembly. Advantageously, a parallel airflow may reduce or minimise a resistance to draw through the airflow channel during use.

Preferably, each of the first slot and the second slot has an elongate shape extending in the longitudinal direction. Advantageously, providing each of the first and second slots with an elongate shape extending in the longitudinal direction may facilitate positioning the planar shape of the wicking element parallel to airflow through the airflow channel during use.

The first slot may have at least one of a different size and a different shape compared to the second slot. Advantageously, providing the first and second slots with at least one of a different size and a different shape may facilitate insertion of the susceptor assembly into the airflow channel through one of the first slot and the second slot during manufacture of the holder assembly.

Preferably, each of the first slot and the second slot has a length and a width extending perpendicular to the length. The length of the second slot may be larger than the length of the first slot. The width of the second slot may be larger than the width of the first slot. Advantageously, providing the second slot with at least one of a larger length and a larger width may facilitate insertion of the susceptor assembly into the airflow channel through the second slot. For example, a thickness of the susceptor assembly may be greater at the central portion of the wicking element due to the additional presence of the susceptor element. Therefore, the first slot may be sized to receive only the first side portion of the wicking element. The second slot may be sized to allow passage of the central portion of the wicking element and the susceptor element through the second slot during manufacture of the holder assembly.

Preferably, the length of each of the first slot and the second slot extends in the longitudinal direction. Advantageously, providing each of the first and second slots with a length extending in the longitudinal direction may facilitate positioning the planar shape of the wicking element parallel to airflow through the airflow channel during use.

Preferably, the shape of the first slot is the same as a cross-sectional shape of the first side portion of the wicking element. The first slot may have a rectangular shape. The first slot may have a rounded rectangular shape.

The second slot may have the same shape as the first slot. The shape of the second slot may be the same as a cross-sectional shape of the second side portion of the wicking element. The shape of the second slot may be the same as the cross-sectional shape of the susceptor assembly through the central portion of the wicking element and the susceptor element. The second slot may have a rectangular shape. The second slot may have a rounded rectangular shape.

The second slot may comprise an elongate portion and an enlarged portion at an end of the elongate portion. Advantageously, the enlarged portion may facilitate passage of a part of the susceptor element through the second slot in embodiments in which the susceptor assembly is inserted into the airflow channel through the second slot during manufacture of the holder assembly. For example, the enlarged portion may facilitate the passage of a fold, join or seam of the susceptor element through the second slot.

The elongate portion of the second slot may have a rectangular shape. The elongate portion of the second slot may have a rounded rectangular shape.

The enlarged portion of the second slot may have a circular shape.

Air may flow through the airflow channel from the first end to the second end during use of the holder assembly in a cartridge with an aerosol-generating system. Preferably, the enlarged portion of the second slot is positioned closer to the second end of the airflow channel than the elongate portion of the second slot. In other words, preferably the enlarged portion of the second slot is downstream of the elongate portion of the second slot. Advantageously, positioning the enlarged portion at the downstream end of the second slot may facilitate positioning of a fold, join or seam of the susceptor element at a downstream end of the susceptor assembly. Advantageously, positioning a fold, join or seam of the susceptor element at a downstream end of the susceptor element may reduce or eliminate interference of airflow with the fold, join or seam during use.

Preferably, the susceptor assembly has a planar shape comprising a first planar surface and a second planar surface opposite the first planar surface. The susceptor assembly may have a thickness extending between the first planar surface and the second planar surface. The thickness of the susceptor assembly may be larger at the central portion of the wicking element than each of the first side portion of the wicking element and the second side portion of the wicking element.

Preferably, the susceptor assembly has an upstream end and a downstream end arranged so that air flows across the susceptor assembly from the upstream end to the downstream end during use of the holder assembly in a cartridge with an aerosol-generating system. The thickness of the susceptor assembly at the central portion of the wicking element may be larger at the downstream end than the upstream end. For example, the thickness of the susceptor assembly may be larger at the downstream end as a result of a fold, join or seam of the susceptor element.

The holder may comprise a first holder portion and a second holder portion connected to the first holder portion, wherein each of the first slot and the second slot is partially defined by the first holder portion and partially defined by the second holder portion. Advantageously, partially defining each of the first and second slots by first and second holder portions may facilitate insertion of the susceptor assembly into the holder during manufacture of the holder assembly. For example, the first and second side portions of the wicking element may be inserted into partial slots defined by the first holder portion or the second holder portion before the first and second holder portions are connected to each other. In this way, the first and second side portions of the wicking element may be automatically received within the first and second slots as the first and second slots are formed during connection of the first and second holder portions to each other.

Each of the first holder portion and the second holder portion may have a tubular shape. The first holder portion and the second holder portion may be connected each other at a position between the first end and the second end of the airflow channel. Each of the first holder portion and the second holder portion may comprise an upstream end and a downstream end, wherein the upstream end of the second holder portion is connected to the downstream end of the first holder portion. The first holder portion may define an upstream part of the first slot and an upstream part of the second slot. The second holder portion may define a downstream part of the first slot and a downstream part of the second slot.

Each of the first holder portion and the second holder portion may extend between the first end of the airflow channel and the second end of the airflow channel. The first holder portion and the second holder portion may be connected each other along one or more joins extending between the first end of the airflow channel and the second end of the airflow channel. Each of the first holder portion and the second holder portion may have a half-tubular shape.

The second holder portion may be connected to the first holder portion by an interference fit.

The holder may comprise a retaining portion arranged to secure the second holder portion to the first holder portion. The retaining portion may be engaged with at least one of the first holder portion and the second holder portion by an interference fit.

The retaining portion may be formed integrally with the first holder portion or the second holder portion. The retaining portion may be formed integrally with the first holder portion and engaged with the second holder portion by an interference fit. The retaining portion may be formed integrally with the second holder portion and engaged with the first holder portion by an interference fit.

The retaining portion may be formed separately from the first holder portion and the second holder portion. The retaining portion may be engaged with both the first holder portion and the second holder portion by an interference fit. The retaining portion may have an annular shape. The retaining portion may extend around a part of the first holder portion and a part of the second holder portion.

The holder may have a tubular shape comprising a first end and a second end. Each of the first slot and the second slot may extend from the first end of the holder so that each of the first slot and the second slot is open at the first end of the holder. Advantageously, the open ends of the first and second slots may facilitate manufacture of the holder assembly. For example, the first and second side portions of the wicking element may be inserted simultaneously into the first and second slots respectively by the open ends of the slots.

Each of the first slot and the second slot may comprise an insertion portion extending from the first end of the holder and a retaining portion extending from the insertion portion. Advantageously, the insertion portions may facilitate insertion of the side portions of the wicking element into the slots.

Preferably, each insertion portion has a larger cross-sectional dimension than the respective retaining portion. Preferably, each insertion portion has a tapered shape. Preferably, each insertion portion has a cross-sectional dimension that decreases in size in a direction along the holder from the first end.

Preferably, each retaining portion has a constant cross-sectional size in a direction along the holder from the first end. Advantageously, providing each retaining portion with a constant cross-sectional size may facilitate retention of the side portions of the wicking element in the slots.

Preferably, the first side portion of the wicking element and the second side portion of the wicking element are received only within the retaining portion of the first slot and the second slot respectively. In other words, preferably the insertion portions of the first and second slots function only to facilitate insertion of the side portions of the wicking element into the retaining portions of the first and second slots.

The holder assembly may comprise a cap connected to the first end of the holder, wherein the cap is arranged to close each of the first slot and the second slot at the first end of the holder. Advantageously, closing the ends of the first and second slots at the first end of the holder may facilitate retention of the first and second side portions of the wicking element in the first and second slots.

In embodiments in which each of the first slot and the second slot has an insertion portion, preferably the cap is arranged to obstruct and seal the insertion portion of each of the first slot and the second slot. Advantageously, obstructing and sealing the insertion portion of each of the first slot and the second slot may reduce or prevent the leakage of a liquid aerosol-forming substrate into the airflow channel through the insertion portions of the first and second slots.

Preferably, the cap is connected to the holder by an interference fit.

Preferably, the first side portion of the wicking element is received within the first slot by an interference fit and the second side portion of the wicking element is received within the second slot by an interference fit. Advantageously, using an interference fit to retain the wicking element in the first and second slots may simplify the manufacture of the holder assembly. Advantageously, using an interference fit to retain the wicking element in the first and second slots may facilitate a seal between the wicking element and the holder at each of the first slot and the second slot.

Preferably, the susceptor element comprises at least one strip of susceptor material having an annular shape and extending around the central portion of the wicking element.

The susceptor element may be formed from any suitable material. Suitable materials include at least one of graphite, molybdenum, silicon carbide, stainless steels, niobium, aluminium and other conductive materials. Advantageously, the susceptor element may be formed of ferromagnetic material. Preferably, the susceptor element may be formed of AISI 430 stainless steel.

The susceptor element may have a relative permeability between 1 and 40000, when measured at a suitable frequency and temperature, for example when measured at frequencies up to 10 kHz at a temperature of 20 degrees Celsius. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the susceptor element.

The susceptor element may be fluid permeable. As used herein, a “fluid permeable” element means an element that allows liquid or gas to permeate through it. A fluid permeable susceptor element may advantageously allow vaporised aerosol-forming substrate to escape through the susceptor element. The susceptor element may comprise a mesh. As used herein, the term “mesh” encompasses grids and arrays of filaments having spaces therebetween. The term mesh also includes woven and non-woven material. In use, vaporised aerosol-forming substrate may advantageously escape from the wicking element through interstices present in the susceptor element when employing a meshed construction for the susceptor element.

The wicking element may comprise a capillary material. A capillary material is a material that is capable of transporting liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. In some embodiments, the capillary material may comprise sponge-like or foam-like material. The structure of the capillary material may form a plurality of small bores or tubes, through which the liquid aerosol-forming substrate can be transported by capillary action. Where the one or more strips comprise interstices, the capillary material may extend into the interstices. In use, liquid aerosol-forming substrate may be drawn into the interstices by capillary action. The wicking element may comprise or consist of an electrically insulating material. The wicking element may comprise a non-metallic material. The wicking element may comprise a hydrophilic material or an oleophilic material. This may advantageously encourage the transport of the aerosol-forming substrate through the wicking element.

The wicking element may preferably comprise or consist of cotton, rayon or glass fibre.

The holder may be formed from any suitable material or combination of materials. Preferably, the holder is formed from a plastic or thermoplastic that is suitable for food or pharmaceutical applications. For example, the holder may comprise at least one of polypropylene, polyetheretherketone (PEEK) and polyethylene. The material is preferably light and non-brittle.

According to a third aspect of the present disclosure there is provided a cartridge for an aerosol-generating system. The cartridge may comprise a holder assembly according to the first aspect or the second aspect of the present disclosure. The cartridge may comprise a reservoir for a liquid aerosol-forming substrate. The reservoir may be in fluid communication with the first side portion of the wicking element and the second side portion of the wicking element by the first slot and the second slot respectively.

According to a fourth aspect of the present disclosure there is provided a cartridge for an aerosol-generating system. The cartridge comprises a holder assembly according to the second aspect of the present disclosure in accordance with any of the examples or embodiments described herein. The cartridge also comprises a reservoir for a liquid aerosol-forming substrate. The reservoir is in fluid communication with the first side portion of the wicking element and the second side portion of the wicking element by the first slot and the second slot respectively.

Preferably, the reservoir extends around at least a portion of an outer surface of the holder. Preferably, the reservoir has an annular shape. The cartridge may comprise a cartridge outer housing extending around at least a portion of the holder, wherein the reservoir is at least partially defined by a space between the outer surface of the holder and an inner surface of the cartridge outer housing.

The cartridge may comprise a retention material contained within the reservoir, the retention material for holding a liquid aerosol-forming substrate. The retention material may be a foam, a sponge, or a collection of fibres. The retention material may be formed from a polymer or a co-polymer. The retention material may be a spun polymer.

Preferably, the cartridge comprises a liquid aerosol-forming substrate contained within the reservoir. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5 percent and about 10 percent, for example about 2 percent.

Preferably, the cartridge comprises a mouthpiece defining an air outlet, wherein the air outlet is in fluid communication with a downstream end of the airflow channel. The mouthpiece may be formed integrally with the holder. The mouthpiece may be formed separately from the holder and connected to the holder. The mouthpiece may be connected to the holder by an interference fit.

In embodiments in which the cartridge comprises a cartridge outer housing, the mouthpiece may be formed integrally with the cartridge outer housing. The mouthpiece may be formed separately from the cartridge outer housing and connected to the cartridge outer housing. The mouthpiece may be connected to the cartridge outer housing by an interference fit.

An upstream end of the airflow channel may form a cartridge air inlet. During use, air enters the cartridge through the cartridge air inlet, flows through the airflow channel, across the susceptor assembly, and exits the cartridge through the air outlet defined by the mouthpiece. Vaporised liquid aerosol-forming substrate generated by the susceptor assembly is entrained in the airflow in the airflow channel. The entrained vapor condenses to form an aerosol for inhalation by a user as the aerosol exits the cartridge through the air outlet defined by the mouthpiece.

The cartridge may comprise at least one seal extending across a portion of the airflow channel. The cartridge may comprise an upstream seal extending across the cartridge air inlet. The upstream seal may be sealed to the holder. The upstream seal may be sealed to the cartridge outer housing. The upstream seal may be sealed to both the holder and the cartridge outer housing. The upstream seal may be frangible or removable. The upstream seal may be arranged to be automatically ruptured upon insertion of the cartridge into an aerosol-generating device.

The cartridge may comprise a downstream seal. The downstream seal may extend across the air outlet defined by the mouthpiece. The downstream seal may be sealed to the mouthpiece. The downstream seal may be frangible or removable.

In embodiments in which the mouthpiece is formed separately from the holder, the downstream seal may extend across a downstream end of the airflow channel defined by the holder. The downstream seal may be sealed to the holder. The downstream seal may be sealed to the cartridge outer housing. The downstream seal may be sealed to both the holder and the cartridge outer housing. The downstream seal may be frangible or removable. The downstream seal may be arranged to be automatically ruptured upon connection of the holder to the mouthpiece by a user.

In embodiments in which the cartridge comprises a mouthpiece, a cartridge outer housing, or both a mouthpiece and a cartridge outer housing, each of the mouthpiece and the cartridge outer housing may be formed from any suitable material or combination of materials. Preferably, the mouthpiece and the cartridge outer housing are formed from a plastic or thermoplastic that is suitable for food or pharmaceutical applications. For example, each of the mouthpiece and the cartridge outer housing may comprise at least one of polypropylene, polyetheretherketone (PEEK) and polyethylene. The material is preferably light and non-brittle.

According to a fifth aspect of the present disclosure there is provided an aerosol-generating system. The aerosol-generating system may comprise a cartridge according to the third aspect or the fourth aspect of the present disclosure. The aerosol-generating system may comprise an aerosol-generating device. The aerosol-generating device may comprise a device housing defining a cavity for receiving at least part of the holder assembly so that the susceptor assembly is positioned within the cavity. The aerosol-generating device may comprise an inductor coil arranged to generate a varying magnetic field within the cavity.

According to a sixth aspect of the present disclosure there is provided an aerosol-generating system. The aerosol-generating system comprises a cartridge according to the fourth aspect of the present disclosure in accordance with any of the examples or embodiments described herein. The aerosol-generating system also comprises an aerosol-generating device. The aerosol-generating device comprises a device housing defining a cavity for receiving at least part of the holder assembly so that the susceptor assembly is positioned within the cavity. The aerosol-generating device also comprises an inductor coil arranged to generate a varying magnetic field within the cavity.

The inductor coil may comprise a flat spiral inductor coil.

The inductor coil may be wound around at last part of the cavity. The inductor coil may have a tubular shape or a helical shape. Preferably, the inductor coil is both tubular and helical. Preferably, the tubular and helical coil has a non-circular cross section, when viewed in a direction perpendicular to the longitudinal length direction of the coil, i.e. in a direction perpendicular to the magnetic centre-axis of the coil. Preferably, the inductor coil is positioned so that the susceptor assembly is positioned inside the inductor coil when the holder assembly is received within the cavity.

Preferably, the aerosol-generating device comprises a power supply.

The power supply may be a DC power supply. In some preferred embodiments, the power supply is a battery, such as a rechargeable lithium ion battery. The power supply may be another form of charge storage device, such as a capacitor. The power supply may require recharging. The power supply may have a capacity that allows for the storage of enough energy for one or more uses of the device. For example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of uses of the device or discrete activations. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

Preferably, the aerosol-generating device comprises a controller. The controller may be arranged to supply a varying electric current from the power supply to the inductor coil.

The controller may comprise a microprocessor, which may be a programmable microprocessor, a microcontroller, or an application specific integrated chip (ASIC) or other electronic circuitry capable of providing control. The controller may comprise further electronic components. The controller may be configured to regulate a supply of current to the inductor coil. Current may be supplied to the inductor coil continuously following activation of the aerosol-generating device or may be supplied intermittently, such as on a puff by puff basis.

The controller may be configured to supply a varying electric current to the inductor coil having a frequency of between about 5 kilohertz and about 500 kilohertz.

The controller may be configured to supply a high frequency varying current to the inductor coil. As used herein, the term “high frequency varying current” means a varying current having a frequency of between about 500 kilohertz and about 30 megahertz. The high frequency varying current may have a frequency of between about 1 megahertz and about 30 megahertz, such as between about 1 megahertz and about 10 megahertz, or such as between about 5 megahertz and about 8 megahertz.

The controller may advantageously comprise a DC/AC inverter. The DC/AC inventor may comprise a Class-C, Class-D or Class-E power amplifier.

The device housing may be elongate. The device housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The device housing may comprises an air inlet. The air inlet may be configured to enable ambient air to enter the device housing. Preferably, the air inlet is in fluid communication with the cavity. The device housing may comprise any suitable number of air inlets. The device housing may comprise a plurality of air inlets.

The aerosol-generating device may include a user interface to activate the device, for example a button to initiate heating of an aerosol-forming substrate.

The aerosol-generating device may comprise a display to indicate a state of the device or of an aerosol-forming substrate.

The aerosol-generating device may comprise a puff sensor, for sensing a user drawing on the aerosol-generating system.

Preferably, the aerosol-generating device is portable. The aerosol-generating device may have a size comparable to a conventional cigar or cigarette. The aerosol-generating device may have a total length between about 30 millimetres and about 150 millimetres. The aerosol-generating device may have an outer diameter between about 5 millimetres and about 30 millimetres.

According to a seventh aspect of the present disclosure there is provided a method of manufacturing a holder assembly for a cartridge for an aerosol-generating system. The holder assembly may be a holder assembly according to the first aspect or the second aspect of the present disclosure. The method may comprise providing a susceptor assembly. The susceptor assembly may comprise a wicking element having a planar shape and comprising a first side portion, a second side portion, and a central portion extending between the first side portion and the second side portion. The susceptor assembly may also comprise a susceptor element extending around at least a part of the central portion of the wicking element. The method may comprise providing a holder defining an airflow channel. The holder may comprise a first slot and a second slot opposite the first slot. The method may comprise inserting the first side portion of the wicking element into the first slot and inserting the second side portion of the wicking element into the second slot so that the central portion of the wicking element and the susceptor element are positioned within the airflow channel.

According to an eighth aspect of the present disclosure there is provided a method of manufacturing a holder assembly for a cartridge for an aerosol-generating system. The holder assembly may be a holder assembly according to the second aspect of the present disclosure in accordance with any of the examples or embodiments described herein. The method comprises providing a susceptor assembly. The susceptor assembly comprises a wicking element having a planar shape and comprising a first side portion, a second side portion, and a central portion extending between the first side portion and the second side portion. The susceptor assembly also comprises a susceptor element extending around at least a part of the central portion of the wicking element. The method also comprises providing a holder defining an airflow channel. The holder comprises a first slot and a second slot opposite the first slot. The method also comprises inserting the first side portion of the wicking element into the first slot and inserting the second side portion of the wicking element into the second slot so that the central portion of the wicking element and the susceptor element are positioned within the airflow channel.

The first slot may have at least one of a different size and a different shape compared to the second slot. The step of inserting the first side portion of the wicking element into the first slot and inserting the second side portion of the wicking element into the second slot may comprise: pushing the first side portion of the wicking element through the second slot and into the airflow channel; pushing the central portion of the wicking element and the susceptor element through the second slot and into the airflow channel; and pushing the second side portion of the wicking element into the second slot and pushing the first side portion of the wicking element into the first slot.

The holder may comprise a first holder portion partially defining each of the first slot and the second slot, and a second holder portion partially defining each of the first slot and the second slot. The step of inserting the first side portion of the wicking element into the first slot and inserting the second side portion of the wicking element into the second slot may comprise: inserting the susceptor assembly into the first holder portion or the second holder portion; and connecting the second holder portion to the first holder portion so that the first holder portion and the second holder portion together define the first slot and the second slot, and so that the first side portion of the wicking element is received within the first slot and the second side portion of the wicking element is received within the second slot.

The holder may have a tubular shape comprising a first end and a second end. Each of the first slot and the second slot may extend from the first end of the holder so that each of the first slot and the second slot is open at the first end of the holder. The step of inserting the first side portion of the wicking element into the first slot and inserting the second side portion of the wicking element into the second slot may comprise sliding the first side portion of the wicking element into the first slot by the open end of the first slot, and simultaneously sliding the second side portion of the wicking element into the second slot by the open end of the second slot.

The invention is defined in the claims. However, below there is provided a non-exhaustive list of non-limiting examples. Any one or more of the features of these examples may be combined with any one or more features of another example, embodiment, or aspect described herein.
Example Ex1: A holder assembly for a cartridge for an aerosol-generating system, the holder assembly comprising:
a susceptor assembly comprising:
   a wicking element having a planar shape and comprising a first side portion, a second side portion, and a central portion extending between the first side portion and the second side portion; and
   a susceptor element extending around at least a part of the central portion of the wicking element; and
a holder defining an airflow channel, wherein the holder comprises a first slot and a second slot opposite the first slot, wherein the first side portion of the wicking element is received within the first slot and the second side portion of the wicking element is received within the second slot so that the central portion of the wicking element and the susceptor element are positioned within the airflow channel.
Example Ex2: The holder assembly according to Example Ex1, wherein only the first side portion of the wicking element is received within the first slot and only the second side portion of the wicking element is received within the second slot.
Example Ex3: The holder assembly according to Example Ex1 or Ex2, wherein the holder comprises a tubular portion at least partially defining the airflow channel, wherein the first slot and the second slot are defined by the tubular portion.
Example Ex4: The holder assembly according to Example Ex1, Ex2 or Ex3, wherein the first slot and the second slot are positioned on opposite sides of the airflow channel.
Example Ex5: The holder assembly according to any preceding Example, wherein the airflow channel defines a longitudinal direction extending between a first end of the airflow channel and a second end of the airflow channel, and wherein the planar shape of the wicking element extends parallel with the longitudinal direction.
Example Ex6: The holder assembly according to any preceding Example, wherein the airflow channel defines a longitudinal direction extending between a first end of the airflow channel and a second end of the airflow channel, wherein each of the first slot and the second slot has an elongate shape extending in the longitudinal direction.
Example Ex7: The holder assembly according to any preceding Example, wherein the first slot has at least one of a different size and a different shape compared to the second slot.
Example Ex8: The holder assembly according to Example Ex7, wherein each of the first slot and the second slot has a length and a width extending perpendicular to the length, and wherein at least one of the length of the second slot and the width of the second slot is larger than the length of the first slot and the width of the first slot respectively.
Example Ex9: The holder assembly according to Example Ex8, wherein the airflow channel defines a longitudinal direction extending between a first end of the airflow channel and a second end of the airflow channel, and wherein the length of each of the first slot and the second slot extends in the longitudinal direction.
Example Ex10: The holder assembly according to Example Ex7, Ex8 or Ex9, wherein the first slot has a rectangular or a rounded rectangular shape.
Example Ex11: The holder assembly according to Example Ex10, wherein the second slot has a rectangular or a rounded rectangular shape.
Example Ex12: The holder assembly according to Example Ex10, wherein the second slot comprises an elongate portion and an enlarged portion at an end of the elongate portion.
Example Ex13: The holder assembly according to Example Ex12, wherein the elongate portion of the second slot has a rectangular or rounded rectangular shape.
Example Ex14: The holder assembly according to Example Ex12 or Ex13, wherein the enlarged portion has a circular shape.
Example Ex15: The holder assembly according to Example Ex12, Ex13 or Ex14, wherein the airflow channel defines a longitudinal direction extending between a first end of the airflow channel and a second end of the airflow channel, wherein air flows through the airflow channel from the first end to the second end during use of the holder assembly in a cartridge with an aerosol-generating system, and wherein the enlarged portion of the second slot is positioned closer to the second end of the airflow channel than the elongate portion of the second slot.
Example Ex16: The holder assembly according to any of Examples Ex1 to Ex6, wherein the holder comprises a first holder portion and a second holder portion connected to the first holder portion, wherein each of the first slot and the second slot is partially defined by the first holder portion and partially defined by the second holder portion.
Example Ex17: The holder assembly according to Example Ex16, wherein each of the first holder portion and the second holder portion has a tubular shape.
Example Ex18: The holder assembly according to Example Ex17, wherein each of the first holder portion and the second holder portion comprises an upstream end and a downstream end, and wherein the upstream end of the second holder portion is connected to the downstream end of the first holder portion.
Example Ex19: The holder assembly according to Example Ex16, wherein the airflow channel defines a longitudinal direction extending between a first end of the airflow channel and a second end of the airflow channel, and wherein each of the first holder portion and the second holder portion extends between the first end and the second end.
Example Ex20: The holder assembly according to Example Ex16 or Ex19, wherein each of the first holder portion and the second holder portion has a half-tubular shape.
Example Ex21: The holder assembly according to any of Examples Ex16 to Ex20, wherein the second holder portion is connected to the first holder portion by an interference fit.
Example Ex22: The holder assembly according to any of Examples Ex16 to Ex21, wherein the holder further comprises a retaining portion arranged to secure the second holder portion to the first holder portion.
Example Ex23: The holder assembly according to Example Ex22, wherein the retaining portion is engaged with at least one of the first holder portion and the second holder portion by an interference fit.
Example Ex24: The holder assembly according to Example Ex22 or Ex23, wherein the retaining portion is formed integrally with the first holder portion or the second holder portion.
Example Ex25: The holder assembly according to Example Ex22 or Ex23, wherein the retaining portion has an annular shape and extends around a part of the first holder portion and a part of the second holder portion.
Example Ex26: The holder assembly according to any of Examples Ex1 to Ex6, wherein the holder has a tubular shape comprising a first end and a second end, and wherein each of the first slot and the second slot extends from the first end of the holder so that each of the first slot and the second slot is open at the first end of the holder.
Example Ex27: The holder assembly according to Example Ex26, wherein each of the first slot and the second slot comprises an insertion portion extending from the first end of the holder and a retaining portion extending from the insertion portion.
Example Ex28: The holder assembly according to Example Ex27, wherein each insertion portion has a tapered shape.
Example Ex29: The holder assembly according to Example Ex27 or Ex28, wherein each insertion portion has a cross-sectional dimension that decreases in size in a direction along the holder from the first end.
Example Ex30: The holder assembly according to Example Ex27, Ex28 or Ex29, wherein each retaining portion has a constant cross-sectional size in a direction along the holder from the first end.
Example Ex31: The holder assembly according to any of Examples Ex27 to Ex30, wherein the first side portion of the wicking element and the second side portion of the wicking element are received only within the retaining portion of the first slot and the second slot respectively.
Example Ex32: The holder assembly according to any of Examples Ex26 to Ex30, further comprising a cap connected to the first end of the holder, wherein the cap is arranged to close each of the first slot and the second slot at the first end of the holder.
Example Ex33: The holder assembly according to any preceding Example, wherein the first side portion of the wicking element is received within the first slot by an interference fit and wherein the second side portion of the wicking element is received within the second slot by an interference fit.
Example Ex34: The holder assembly according to any preceding Example, wherein the susceptor assembly has a planar shape comprising a first planar surface and a second planar surface opposite the first planar surface.
Example Ex35: The holder assembly according to Example Ex34, wherein the susceptor assembly has a thickness extending between the first planar surface and the second planar surface, and wherein the thickness of the susceptor assembly is larger at the central portion of the wicking element than each of the first side portion of the wicking element and the second side portion of the wicking element.
Example Ex36: The holder assembly according to Example Ex34 or Ex35, wherein the susceptor assembly has an upstream end and a downstream end arranged so that air flows across the susceptor assembly from the upstream end to the downstream end during use of the holder assembly in a cartridge with an aerosol-generating system, wherein the susceptor assembly has a thickness extending between the first planar surface and the second planar surface, and wherein the thickness of the susceptor assembly at the central portion of the wicking element is larger at the downstream end than the upstream end.
Example Ex37: The holder assembly according to any preceding Example, wherein the susceptor element comprises at least one strip of susceptor material having an annular shape and extending around the central portion of the wicking element.
Example Ex38: A cartridge for an aerosol-generating system, the cartridge comprising:
   a holder assembly according to any preceding Example; and
   a reservoir for a liquid aerosol-forming substrate, wherein the reservoir is in fluid communication with the first side portion of the wicking element and the second side portion of the wicking element by the first slot and the second slot respectively.
Example Ex39: The cartridge according to Example Ex38, wherein the reservoir extends around at least a portion of an outer surface of the holder.
Example Ex40: The cartridge according to Example Ex38 or Ex39, wherein the reservoir has an annular shape.
Example Ex41: The cartridge according to Example Ex38, Ex39 or Ex40, further comprising a mouthpiece defining an air outlet, wherein the air outlet is in fluid communication with a downstream end of the airflow channel.
Example Ex42: An aerosol-generating system comprising:
a cartridge according to any of Examples Ex38 to Ex41; and
an aerosol-generating device comprising:
   a device housing defining a cavity for receiving at least part of the holder assembly so that the susceptor assembly is positioned within the cavity; and
   an inductor coil arranged to generate a varying magnetic field within the cavity.
Example Ex43: A method of manufacturing a holder assembly for a cartridge for an aerosol-generating system, the method comprising:
providing a susceptor assembly comprising:
   a wicking element having a planar shape and comprising a first side portion, a second side portion, and a central portion extending between the first side portion and the second side portion; and
   a susceptor element extending around at least a part of the central portion of the wicking element;
providing a holder defining an airflow channel, wherein the holder comprises a first slot and a second slot opposite the first slot; and
inserting the first side portion of the wicking element into the first slot and inserting the second side portion of the wicking element into the second slot so that the central portion of the wicking element and the susceptor element are positioned within the airflow channel.
Example Ex44: A method according to Example Ex43, wherein the first slot has at least one of a different size and a different shape compared to the second slot, and wherein the step of inserting the first side portion of the wicking element into the first slot and inserting the second side portion of the wicking element into the second slot comprises:
pushing the first side portion of the wicking element through the second slot and into the airflow channel;
pushing the central portion of the wicking element and the susceptor element through the second slot and into the airflow channel; and
pushing the second side portion of the wicking element into the second slot and pushing the first side portion of the wicking element into the first slot.
Example Ex45: A method according to Example Ex43, wherein the holder comprises a first holder portion partially defining each of the first slot and the second slot, wherein the holder further comprises a second holder portion partially defining each of the first slot and the second slot, and wherein the step of inserting the first side portion of the wicking element into the first slot and inserting the second side portion of the wicking element into the second slot comprises:
inserting the susceptor assembly into the first holder portion or the second holder portion; and
connecting the second holder portion to the first holder portion so that the first holder portion and the second holder portion together define the first slot and the second slot, and so that the first side portion of the wicking element is received within the first slot and the second side portion of the wicking element is received within the second slot.
Example Ex46: A method according to Example Ex43, wherein the holder has a tubular shape comprising a first end and a second end, wherein each of the first slot and the second slot extends from the first end of the holder so that each of the first slot and the second slot is open at the first end of the holder, and wherein the step of inserting the first side portion of the wicking element into the first slot and inserting the second side portion of the wicking element into the second slot comprises:
sliding the first side portion of the wicking element into the first slot by the open end of the first slot, and simultaneously sliding the second side portion of the wicking element into the second slot by the open end of the second slot.

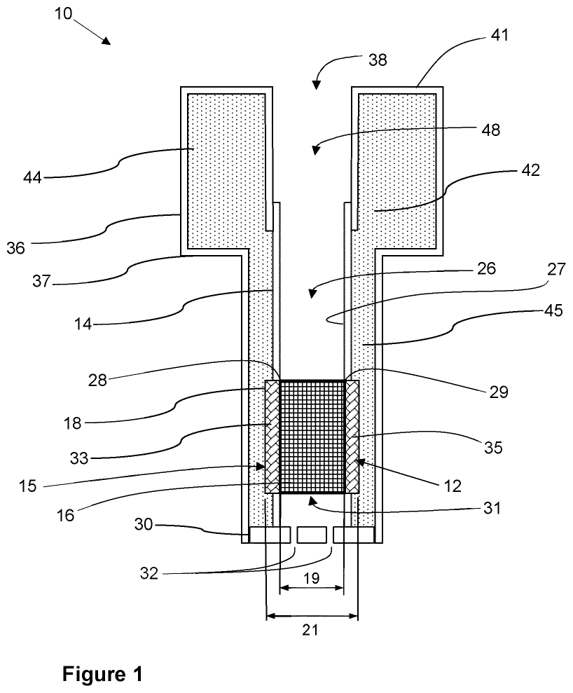

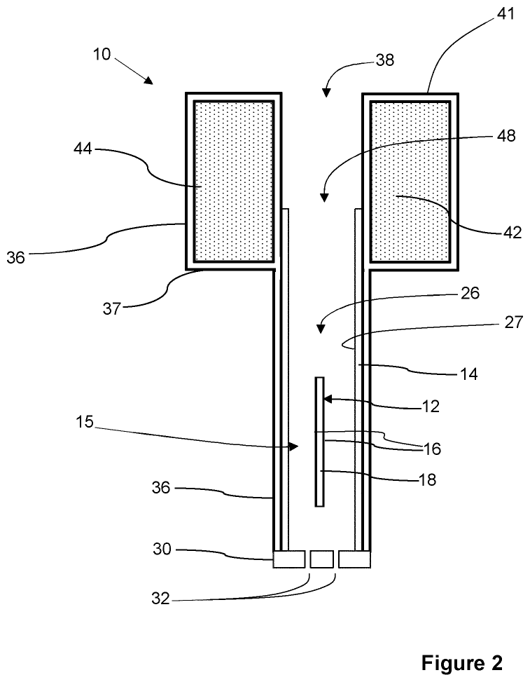

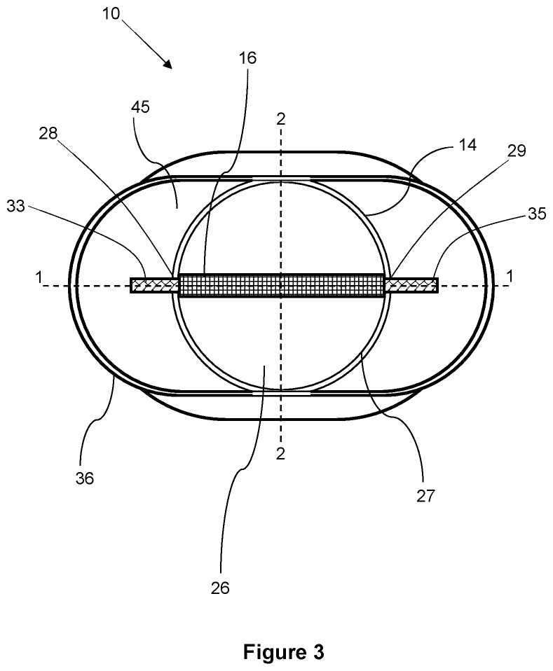

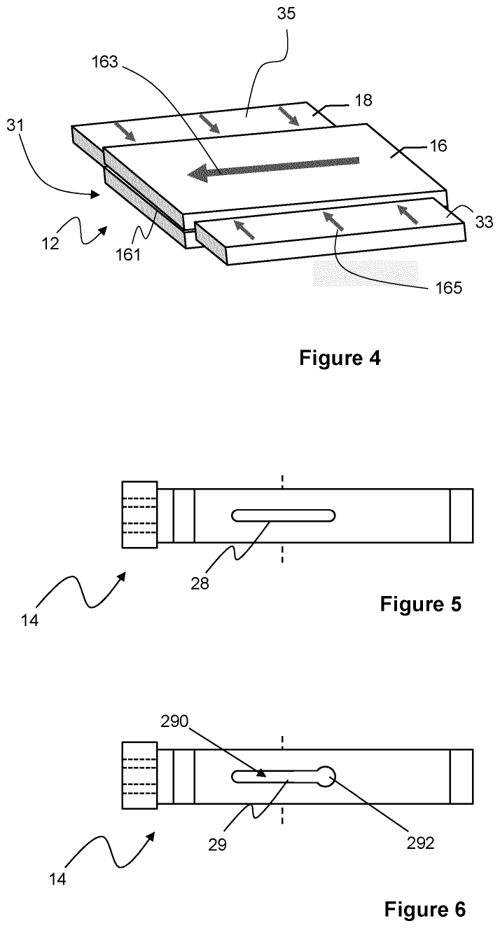

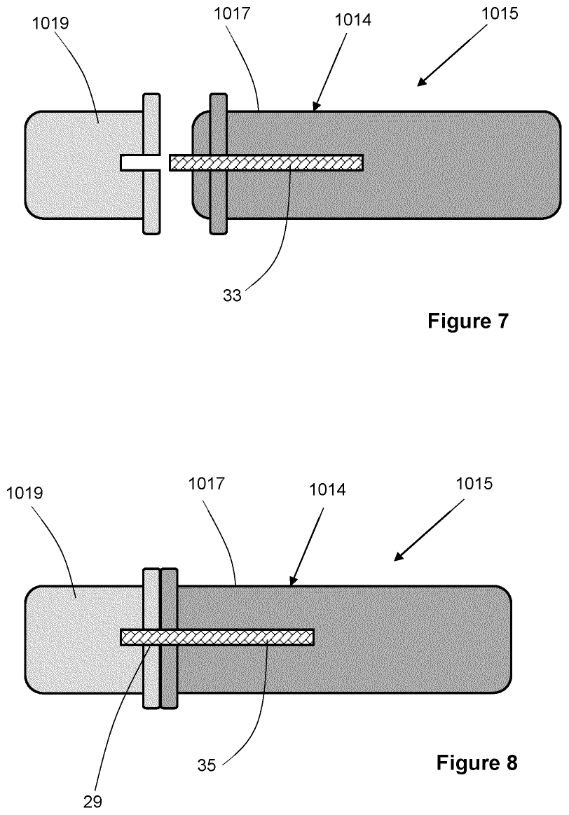

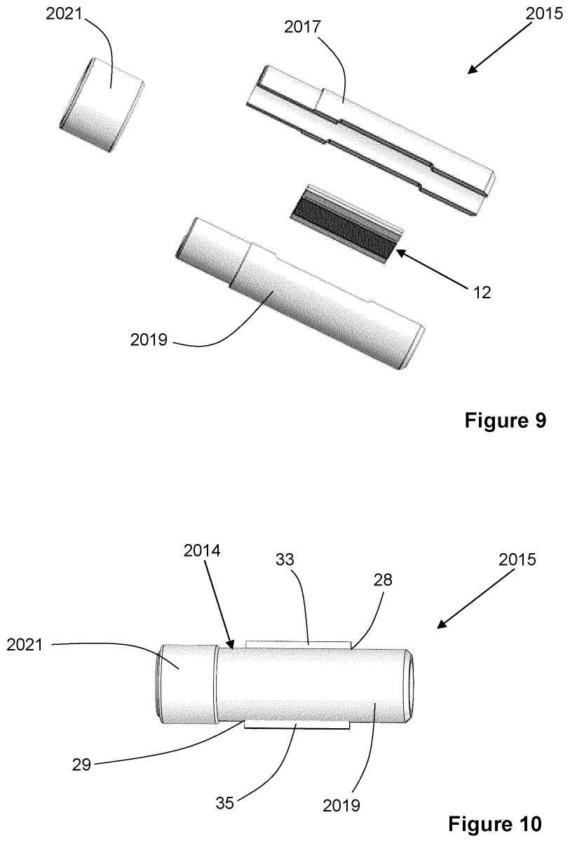

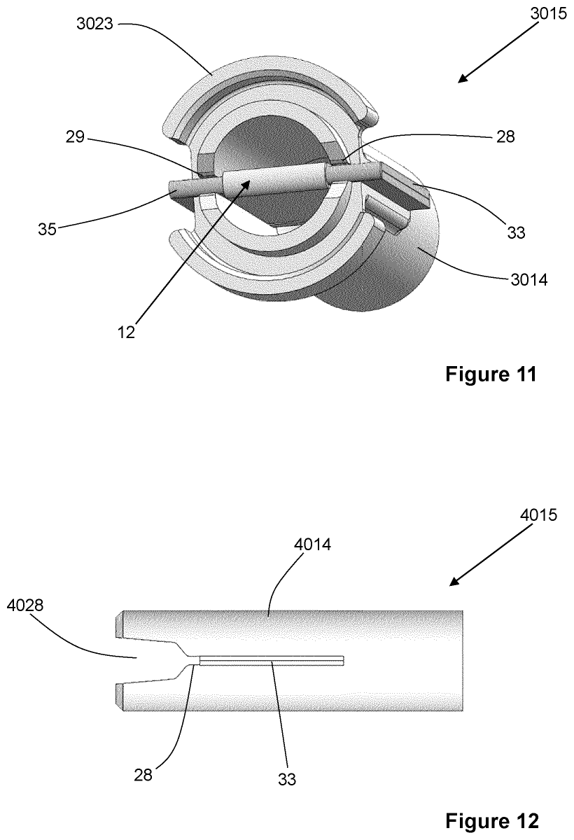

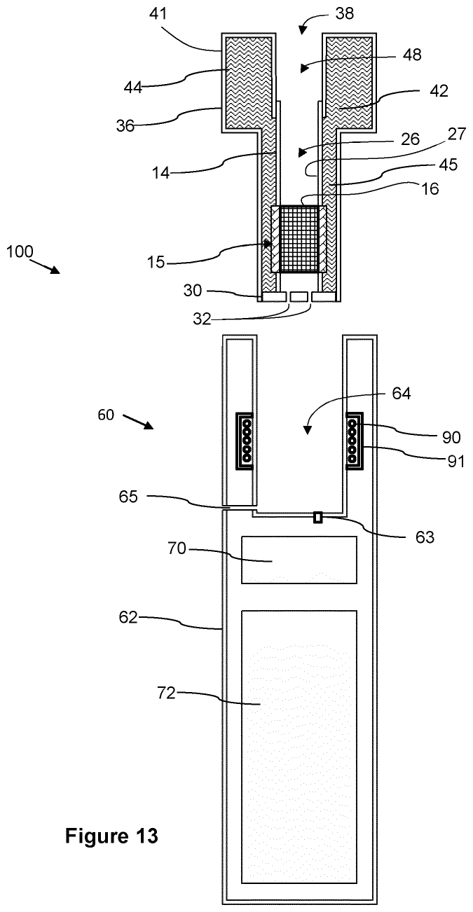

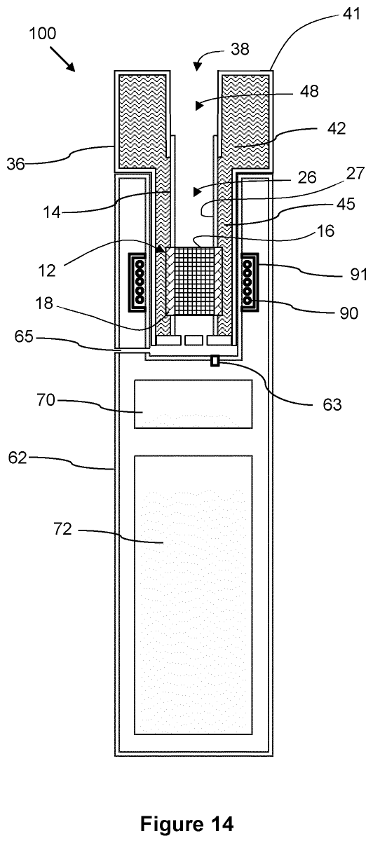

Examples will now be further described with reference to the figures in which:
FIG. 1 shows a longitudinal cross-sectional view of a cartridge according to an embodiment of the present disclosure, the cartridge comprising a holder;
FIG. 2 shows a further longitudinal cross-sectional view of the cartridge of FIG. 1 rotated through 90 degrees;
FIG. 3 shows a lateral cross-sectional view of the cartridge of FIGS. 1 and 2;
FIG. 4 shows a perspective view of the susceptor assembly of the cartridge of FIGS. 1 to 3;
FIG. 5 shows a first side view of a holder for a cartridge according to an embodiment of the present disclosure;
FIG. 6 shows a second side view of the holder of FIG. 5;
FIG. 7 shows a side view of an alternative holder assembly according to an embodiment of the present disclosure with the holder assembly in a partially assembled state;
FIG. 8 shows a side view of the holder assembly of FIG. 7 in a fully assembled state
FIG. 9 shows an exploded perspective view of a further alternative holder assembly according to an embodiment of the present disclosure;
FIG. 10 shows the holder assembly of FIG. 9 in an assembled state;
FIG. 11 shows a perspective view of a further alternative holder assembly according to an embodiment of the present disclosure;
FIG. 12 shows a side view of a further alternative holder assembly according to an embodiment of the present disclosure;
FIG. 13 shows a longitudinal cross-sectional view of an aerosol-generating system comprising the cartridge of FIGS. 1 to 3 and an aerosol-generating device, in which the cartridge is decoupled from the aerosol generating device; and
FIG. 14 shows a longitudinal cross-sectional view of the aerosol-generating system of FIG. 13, wherein the cartridge is coupled to the aerosol generating device.

FIGS. 1 and 2 show two longitudinal cross-sectional views of a cartridge 10 for an aerosol-generating system, the cartridge 10 according to an embodiment of the present disclosure. The two cross-sectional views are taken in two planes perpendicular to one another. FIG. 3 shows a lateral cross-sectional view of the cartridge 10. The cross-sectional view of FIG. 1 is denoted by the line 1-1 in FIG. 3. The cross-sectional view of FIG. 2 is denoted by the line 2-2 in FIG. 3.

The cartridge 10 comprises a holder 14 and a susceptor assembly 12 mounted in the holder 14. Together, the susceptor assembly 12 and the holder 14 form a holder assembly 15. The susceptor assembly 12 is planar, and thin, having a thickness dimension that is substantially smaller than a length dimension and a width dimension. The susceptor assembly 12 is shaped in the form of a rectangle, and comprises a susceptor element 16 wrapped around a wicking element 18. The width 19 of the susceptor element 16 is smaller than the width 21 of the wicking element 18, with the susceptor element 16 wrapped around a central portion 31 of the wicking element 18 to define outer, exposed portions of the wicking element 18 which are not enclosed by the susceptor element 16. The outer, exposed portions of the wicking element 18 comprise a first side portion 33 and a second side portion 35. The first and second side portions 33, 35 protrude through first and second slots 28, 29 respectively, into one of two channels 45. The first and second slots 28, 29 are arranged on opposed sides of an internal side wall 27 of the holder 14. The internal side wall 27 defines an airflow channel 26 in which the susceptor assembly 12 is positioned.

The susceptor element 16 comprises a sintered mesh formed from ferritic stainless steel filaments and austenitic stainless steel filaments. The wicking element 18 comprises a porous body of rayon filaments. The wicking element 18 is configured to deliver liquid aerosol-forming substrate via the first and second side portions 33, 35 to the central portion 31 and the susceptor element 16 wrapped around the central portion 31.

The susceptor element 16 is configured to be heatable by penetration with varying magnetic field, for vaporising an aerosol-forming substrate. The first and second side portions 33, 35 of the wicking element 18 protrude through the first and second slots 28, 29 respectively in the holder 14, such that the holder 14 supports the susceptor assembly 12 in position in the airflow channel 26.

The susceptor assembly 12 is partially arranged inside the airflow channel 26 of the tubular holder 14, and extends in a plane parallel to a central longitudinal axis of the holder 14. The susceptor element 16 is arranged entirely within the airflow channel 26 of the holder 14 and the outer, exposed portions 20 of the wicking element 18 extend through the pair of openings 28 in the internal side wall 27 of the holder 14 into the two channels 45. The first and second side portions 33, 35 of the wicking element 18 define mounting regions of the susceptor assembly 12 for mounting the susceptor assembly 12 in the holder 14. The first and second side portions 33, 35 of the wicking element 18 are received and retained within the first and second slots 28, 29 by interference fit. Advantageously, an interference fit may simplify the manufacture of the holder assembly 15. Advantageously, an interference fit may reduce or prevent leakage of liquid aerosol-forming substrate from the channels 45 into the airflow channel 26.

The cartridge 10 has an outer housing 36 having a mouth end and a connection end opposite to the mouth end. The mouth end of the outer housing 36 defines a mouthpiece 41 having an air outlet 38 at the mouth end of the cartridge 10. During use, aerosol is delivered through the air outlet 38 to a user for inhalation. The connection end of the outer housing 36 is configured for connection of the cartridge 10 to an aerosol-generating device, as described in detail below. The outer housing 36 defines an internal space in which the holder assembly 15 is contained. The holder assembly 15 is received within the internal space of the outer housing 36 by an interference fit. The holder assembly 15 is positioned within the outer housing 36 so that the susceptor assembly 12 and the holder 14 are located towards the connection end of the cartridge 10. The outer housing 36 is formed from a mouldable plastics material, such as polypropylene.

The external width of the outer housing 36 is greater at the mouth end of the cartridge 10 than at the connection end to define the mouthpiece 41. The change in the external width of the outer housing 36 is a step change that forms a shoulder 37. The shoulder 37 enables the connection end of the cartridge 10 to be received in a cavity of an aerosol-generating device, with the shoulder 37 locating the cartridge in the correct position in the device. The shoulder 37 also enables the mouthpiece 41 to remain outside of the aerosol-generating device, with the mouth end of the cartridge 10 conforming to the external shape of the aerosol-generating device.

The cartridge 10 further comprises a liquid reservoir 44. The liquid reservoir 44 is defined in the cartridge 10 for holding a liquid aerosol-forming substrate 42.

The liquid reservoir 44 is positioned within the mouthpiece 41 and comprises an annular space defined by the outer housing 36.

An internal side wall of the mouthpiece 41 defines a further airflow channel 48 that extends between a downstream end of the airflow channel 26 of the holder 14 and the air outlet 38 of the mouthpiece 41.

The liquid reservoir 44 further comprises the two channels 45, the two channels 45 being defined between the outer housing 36 at the connection end and the holder 14. The two channels 45 extend from the annular space defined by the mouthpiece 41 to the connection end of the cartridge 10. The first and second side portions 33, 35 of the wicking element 18 extend through the first and second slots 28, 29 in the internal side wall 27 of the holder 14 into the two channels 45 on opposite sides of the holder 14.

The cartridge 10 also comprises a cap 30 that partially closes an upstream end of the airflow channel 26. The cap 30 comprises a plurality of air inlets 32 that enable air to be drawn into the airflow channel 26 through the partially closed end.

FIG. 4 shows a perspective view of the susceptor assembly 12. FIG. 4 includes an arrow 163 representing the passage of air flow over the susceptor element 16 from an upstream end of the susceptor assembly 12 to a downstream end of the susceptor assembly 12. FIG. 4 also includes arrows 165 representing the flow of liquid aerosol-forming substrate into the first and second side portions 33, 35 of the wicking element 18.

The susceptor element 16 is defined by a single strip of susceptor material wrapped around the central portion 31 of the wicking element 18. The wicking element 18 has a uniform thickness. The strip of susceptor material overlies opposing upper and lower planar surfaces of the wicking element 18, as well as opposing upstream and downstream faces of the wicking element 18. First and second ends of the strip of susceptor material extend towards each other from opposite directions along the downstream end face of the wicking element 18 to form a seam 161 in the susceptor element 16. As a result of the seam 161, the thickness of a central part of the susceptor assembly 12 comprising the central portion 31 of the wicking element 18 and the susceptor element 16 is larger at the downstream end of the wicking element 18.

FIGS. 5 and 6 show first and second side views of the holder 14. The first slot 28 has a shape that is substantially the same as the cross-sectional shape of the first side portion 33 of the wicking element 18. The first slot 28 is sized to receive the first side portion 33 of the wicking element 18 by an interference fit.

To facilitate insertion of the susceptor assembly 12 into the holder 14 during manufacture of the holder assembly 15, the second slot 29 has a slightly different size and shape compared to the first slot 28. The second slot 29 comprises an elongate portion 290 having a similar shape to the first slot 28. A height of the elongate portion 290 of the second slot 29 is slightly larger than a height of the first slot 28 to accommodate the combined thickness of the central portion 31 of the wicking 18 and the susceptor element 16. The second slot 29 also comprises an enlarged portion 292 at a downstream end of the elongate portion 290. The enlarged portion 292 accommodates the additional thickness of the susceptor assembly 12 resulting from the seam 161 of the susceptor element 16.

During manufacture of the holder assembly 15, the first side portion 33 of the wicking element 18 is pushed through the second slot 29 and into the airflow channel 26. Next, the central portion 31 of the wicking element 18 and the susceptor element 16 are pushed through the second slot 29 and into the airflow channel 29. Finally, the second side portion 35 of the wicking element 18 is pushed into the second slot 29 and at the same time the first side portion 33 of the wicking element 18 is pushed into the first slot 28.

FIGS. 7 and 8 show first and second side views of an alternative holder assembly 1015 that may be used with the cartridge 10 of FIGS. 1 to 3. The holder assembly 1015 is shown in a partially assembled state in FIG. 7 and a fully assembled state in FIG. 8.

The holder assembly 1015 comprises a holder 1014 and a susceptor assembly 12. The susceptor assembly 12 is identical to the susceptor assembly 12 of FIGS. 1 to 6.

The holder 1014 comprises a first holder portion 1017 and a second holder portion 1019. Each of the first and second holder portions 1017, 1019 comprises a pair of open ended slots that form part of the first and second slots 28, 29 when the holder assembly 15 is fully assembled. During manufacture, parts of the first and second side portions 33, 35 of the wicking element 18 are inserted into the open ended slots of the first holder portion 1017, as shown in FIG. 7. Next, the second holder portion 1019 is pushed onto the first holder portion 1017 so that the remaining parts of the first and second side portions 33, 35 of the wicking element 18 are received within the open ended slots of the second holder portion 1019, as shown in FIG. 8. Part of the first holder portion 1017 is received within the second holder portion 1019 by an interference fit to connect the second holder portion 1019 to the first holder portion 1017.

FIGS. 9 and 10 show two views of a further alternative holder assembly 2015 that may be used with the cartridge 10 of FIGS. 1 to 3. The holder assembly 2015 is shown in exploded state in FIG. 9 and a fully assembled state in FIG. 10.

The holder assembly 2015 comprises a holder 2014 and a susceptor assembly 12. The susceptor assembly 12 is identical to the susceptor assembly 12 of FIGS. 1 to 6.

The holder 2014 comprises a first holder portion 2017 and a second holder portion 2019. Each of the first and second holder portions 2017, 2019 has a half-tubular shape and defines a longitudinal half of each of the first and second slots 28, 29. During manufacture, the first and second side portions 33, 35 of the wicking element 18 are positioned between the first and second holder portion 2017, 2019. The first and second holder portions 2017, 2019 are then brought into contact with each other to form the first and second slots 28, 29 with the first and second side portions 33, 35 of the wicking element 18 positioned within the first and second slots 28, 29. A retaining portion 2021 in the form of an annular ring is then pushed over an end of the combined first and second holder portions 2017, 2019 to secure the first and second holder portions 2017, 2019 to each other.

FIG. 11 shows a perspective view of a further alternative holder assembly 3015 that may be used with the cartridge 10 of FIGS. 1 to 3. The holder assembly 3015 comprises a holder 3014 and a susceptor assembly 12. The susceptor assembly 12 is identical to the susceptor assembly 12 of FIGS. 1 to 6.

The holder 3014 has a tubular shape, wherein the first and second slots 28, 29 are open ended slots that extend from an upstream end 3023 of the holder 3014. During manufacture, the first and second side portions 33, 35 of the wicking element 18 are inserted into the first and second slots 28, 29 through the open ends of the first and second slots 28, 29. The first and second side portions 33, 35 of the wicking element 18 are retained in the first and second slots 28, 29. The open ends of the first and second slots 28, 29 may be closed after insertion of the susceptor assembly by a cap 30 as described above with reference to FIGS. 1 and 2.

FIG. 12 shows a side view of a further alternative holder assembly 4015 that may be used with the cartridge 10 of FIGS. 1 to 3. The holder assembly 4015 comprises a holder 4014 and a susceptor assembly 12. The susceptor assembly 12 is identical to the susceptor assembly 12 of FIGS. 1 to 6. The holder 4014 is a variation of the holder 3014 of FIG. 11 and differs by the shape of the open ends of the first and second slots 28, 29. Specifically, the first and second slots 28, 29 each comprise a taper insertion portion 4028 to facilitate insertion of the first and second side portions 33, 35 of the wicking element 18 into the first and second slots 28, 29.

FIG. 13 shows a schematic illustration of a cross-section of an aerosol-generating system 100 according to the present disclosure, with the cartridge 10 decoupled from an aerosol generating device 60.

The cartridge 10 is identical to that presented in FIGS. 1, 2 and 3, and their corresponding descriptions.

The aerosol-generating device 60 comprises a generally cylindrical device housing 62 having a connection end and a distal end opposite the connection end. A cavity 64 for receiving the connection end of the cartridge 10 is located at the connection end of the device 60, and an air inlet 65 is provided through the device housing 62 at the base of the cavity 64 to enable ambient air to be drawn into the cavity 64.

The device 60 further comprises an inductive heating arrangement arranged within the device outer housing 62. The inductive heating arrangement includes an inductor coil 90, a controller 70 and a power supply 72. The power supply 72 comprises a rechargeable nickel cadmium battery, which is rechargeable via an electrical connector (not shown) at the distal end of the device 60. The controller 70 is connected to the power supply 72, and to the inductor coil 90, such that the controller 70 controls the supply of power to the inductor coil 90. The controller 70 is configured to supply an alternating current to the inductor coil 90.

The single inductor coil 90 is positioned around the susceptor assembly 12 when the cartridge 10 is received in the cavity 64. The inductor coil 90 is made with a copper wire having a round circular section, and is arranged on a coil former element (not shown). The inductor coil 90 is a helical coil, and defines a circular cross section when viewed along the longitudinal axis of the aerosol-generating device 60.

The inductor coil 90 is configured such that when the alternating current is supplied to the inductor coil 90, the inductor coil 90 generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce stray power losses from the generated magnetic field.

FIG. 14 shows a schematic illustration of a cross section of the aerosol-generating system 100 of FIG. 13, but with the cartridge 10 coupled to the aerosol-generating device 60.

In operation, when a user puffs on the mouthpiece 41 of the cartridge 10, ambient air is drawn into the base of the cavity 64 through air inlet 65, and into the cartridge 10 through the air inlets 32 in the cap 30 of the cartridge 10. The ambient air flows through the cartridge 10 from the cap 30, through the airflow channel 26 and over the susceptor assembly 12, and through the air outlet 38.

The controller 70 controls the supply of electrical power from the power supply 72 to the inductor coil 90 when the system is activated.

The controller 72 is coupled to an airflow sensor 63. The airflow sensor 63 is in fluid communication with the passage of ambient air which is drawn through the system by the user. The controller 72 supplies electrical power to the inductor coil 90 when user-applied puffs on the cartridge 10 are detected by the airflow sensor 63.

When the system 100 is activated, an alternating current is established in the inductor coil 90, which generates alternating magnetic fields in the cavity 64 in which the susceptor assembly 12 is located, causing the susceptor element 16 to heat. Liquid aerosol-forming substrate in the channels 45 is drawn into the susceptor assembly 12 through the wicking element 18 towards the susceptor element 16. The liquid aerosol-forming substrate 42 at the susceptor element 16 is heated, and volatile compounds from the heated aerosol-forming substrate are released into the airflow channel 26 of the cartridge 10, and cool to form an aerosol. The aerosol is entrained in the air being drawn through the airflow channel 26 of the cartridge 10, and is drawn out of the cartridge 10 at the air outlet 38 for inhalation by the user.

1.-15. (canceled)

16. A holder assembly for a cartridge for an aerosol-generating system, the holder assembly comprising:
a susceptor assembly comprising:
a wicking element having a planar shape and comprising a first side portion, a second side portion, and a central portion extending between the first side portion and the second side portion, and
a susceptor element extending around at least a part of the central portion of the wicking element; and
a holder defining an airflow channel, wherein the holder comprises a first slot and a second slot opposite the first slot, and wherein the first side portion of the wicking element is received within the first slot and the second side portion of the wicking element is received within the second slot so that the central portion of the wicking element and the susceptor element are positioned within the airflow channel.

17. The holder assembly according to claim 16, wherein the first slot has at least one of a different size and a different shape compared to the second slot.

18. The holder assembly according to claim 16,
wherein the holder further comprises a first holder portion and a second holder portion connected to the first holder portion, and
wherein each of the first slot and the second slot is partially defined by the first holder portion and partially defined by the second holder portion.

19. The holder assembly according to claim 18,
wherein each of the first holder portion and the second holder portion comprises an upstream end and a downstream end, and
wherein the upstream end of the second holder portion is connected to the downstream end of the first holder portion.

20. The holder assembly according to claim 18,
wherein the airflow channel defines a longitudinal direction extending between a first end of the airflow channel and a second end of the airflow channel, and
wherein each of the first holder portion and the second holder portion extends between the first end and the second end.

21. The holder assembly according to claim 18, wherein each of the first holder portion and the second holder portion has a half-tubular shape.

22. The holder assembly according to claim 16,
wherein the holder has a tubular shape comprising a first end and a second end, and
wherein each of the first slot and the second slot extends from the first end of the holder so that each of the first slot and the second slot is open at the first end of the holder.

23. The holder assembly according to claim 22, wherein each of the first slot and the second slot comprises an insertion portion extending from the first end of the holder and a retaining portion extending from the insertion portion.

24. The holder assembly according to claim 23, wherein each insertion portion has a tapered shape.

25. A cartridge for an aerosol-generating system, the cartridge comprising:
a holder assembly according to claim 16; and
a reservoir for a liquid aerosol-forming substrate, wherein the reservoir is in fluid communication with the first side portion of the wicking element and the second side portion of the wicking element by the first slot and the second slot, respectively.

26. An aerosol-generating system, comprising:
a cartridge according to claim 25; and
an aerosol-generating device comprising:
a device housing defining a cavity configured to receive at least part of the holder assembly so that the susceptor assembly is positioned within the cavity, and
an inductor coil arranged to generate a varying magnetic field within the cavity.

27. A method of manufacturing a holder assembly for a cartridge for an aerosol-generating system, the method comprising:
providing a susceptor assembly comprising:
a wicking element having a planar shape and comprising a first side portion, a second side portion, and a central portion extending between the first side portion and the second side portion, and
a susceptor element extending around at least a part of the central portion of the wicking element;
providing a holder defining an airflow channel, wherein the holder comprises a first slot and a second slot opposite the first slot; and
inserting the first side portion of the wicking element into the first slot and inserting the second side portion of the wicking element into the second slot so that the central portion of the wicking element and the susceptor element are positioned within the airflow channel.

28. The method according to claim 27,
wherein the first slot has at least one of a different size and a different shape compared to the second slot, and
wherein the step of inserting the first side portion of the wicking element into the first slot and inserting the second side portion of the wicking element into the second slot comprises:
pushing the first side portion of the wicking element through the second slot and into the airflow channel,
pushing the central portion of the wicking element and the susceptor element through the second slot and into the airflow channel, and
pushing the second side portion of the wicking element into the second slot and pushing the first side portion of the wicking element into the first slot.

29. The method according to claim 27,
wherein the holder further comprises:
a first holder portion partially defining each of the first slot and the second slot, and
a second holder portion partially defining each of the first slot and the second slot, and
wherein the step of inserting the first side portion of the wicking element into the first slot and inserting the second side portion of the wicking element into the second slot comprises:
inserting the susceptor assembly into the first holder portion or the second holder portion, and
connecting the second holder portion to the first holder portion so that the first holder portion and the second holder portion together define the first slot and the second slot, and so that the first side portion of the wicking element is received within the first slot and the second side portion of the wicking element is received within the second slot.

30. The method according to claim 27,
wherein the holder has a tubular shape comprising a first end and a second end,
wherein each of the first slot and the second slot extends from the first end of the holder so that each of the first slot and the second slot is open at the first end of the holder, and
wherein the step of inserting the first side portion of the wicking element into the first slot and inserting the second side portion of the wicking element into the second slot comprises sliding the first side portion of the wicking element into the first slot by the open end of the first slot, and simultaneously sliding the second side portion of the wicking element into the second slot by the open end of the second slot.
